(19) United States
(12) Patent Application Publication
(10) Pub. No.: US 2026/0163510 A1
(43) Pub. Date: Jun. 11, 2026

(54) SINGLE-PHASE INDUCTION MOTOR DRIVE SYSTEM AND MOTOR DRIVE METHOD

(71) Applicant: DELTA ELECTRONICS, INC., Taoyuan City (TW)

(72) Inventors: Po-Yen CHEN, Taoyuan City (TW); Shao-Chuan CHIEN, Taoyuan City (TW); Lei-Chung HSING, Taoyuan City (TW)

(21) Appl. No.: 19/366,492

(22) Filed: Oct. 22, 2025

Related U.S. Application Data
(60) Provisional application No. 63/730,464, filed on Dec. 11, 2024.

(30) Foreign Application Priority Data
Jun. 19, 2025 (CN) 202510822901.7

(51) Int. Cl. H02P 27/04; H02P 1/42

(52) U.S. Cl. CPC H02P 27/04; H02P 1/423; H02P 2205/01; H02P 2207/01

(57) ABSTRACT

A motor drive method comprising: obtaining a frequency variation curve corresponding to a single-phase induction motor, wherein the frequency variation curve is configured to indicate multiple set frequencies, and comprises a target frequency; providing a power command to the single-phase induction motor, wherein an initial frequency of the power command is less than the target frequency; when one of the multiple set frequencies corresponding to the present time is greater than the initial frequency, controlling the present frequency of the power command according to the frequency variation curve; when one of the multiple set frequencies is less than or equal to the initial frequency, maintaining the present frequency; when the output current is greater than or equal to the current threshold, fixing the present voltage; and when the output current is lower than the current threshold, increasing the present voltage.

### CROSS-REFERENCE TO RELATED APPLICATION

This application claims priority to U.S. Provisional Application Ser. No. 63/730,464 filed Dec. 11, 2024, and China Application Serial Number 202510822901.7, filed Jun. 19, 2025, the disclosures of which are incorporated herein by reference in their entireties.

### BACKGROUND

### Technical Field

The present disclosure relates to a single-phase induction motor, and more particularly to a single-phase induction motor drive system and a motor drive method thereof.

### Description of Related Art

Single-phase induction motors are widely applied alternating current (AC) motors, which are often used in devices such as home appliances, fans and water pumps. Since the single-phase AC power used by the single-phase induction motor cannot directly generate a rotating magnetic field, an auxiliary circuit, such as a capacitor, is required for starting rotor and stable operation.

### SUMMARY

One aspect of the present disclosure is a single-phase induction motor drive system, comprising a single-phase induction motor and a processor. The single-phase induction motor comprises a stator and a rotor. The processor is coupled to the stator, and is configured to provide a power command to the stator. The processor is configured to obtain a frequency variation curve, the frequency variation curve is configured to indicate a plurality of set frequencies corresponding to different times, and comprises a target frequency corresponding to a time when the single-phase induction motor is in stable operation. The processor is configured to determine the following conditions to provide the power command: setting the present frequency of the power command with an initial frequency, such that the stator is configured to drive the rotor through the power command, wherein the initial frequency is less than the target frequency; when one of the plurality of set frequencies corresponding to the present time is greater than the initial frequency, changing to control the present frequency of the power command according to the frequency variation curve; when one of the plurality of set frequencies corresponding to the present time is less than or equal to the initial frequency, maintaining the present frequency of the power command at the initial frequency, and determining whether an output current to the stator is greater than or equal to a current threshold; when the output current to the stator is greater than or equal to the current threshold, fixing the present voltage of the power command; and when the output current to the stator is lower than the current threshold, increasing the present voltage of the power command.

Another aspect of the present disclosure is a motor drive method, comprising: obtaining, by a processor, a frequency variation curve corresponding to a single-phase induction motor, wherein the frequency variation curve is configured to indicate a plurality of set frequencies corresponding to different times, and comprises a target frequency corresponding to a time when the single-phase induction motor is in stable operation; providing, by the processor, a power command to the single-phase induction motor, such that a stator of the single-phase induction motor drives a rotor of the single-phase induction motor to rotate, wherein an initial frequency of the power command is less than the target frequency; when one of the plurality of set frequencies corresponding to the present time is greater than the initial frequency, controlling the present frequency of the power command according to the frequency variation curve by the processor; when one of the plurality of set frequencies corresponding to the present time is less than or equal to the initial frequency, maintaining the present frequency of the power command at the initial frequency, and determining whether an output current to the stator is greater than or equal to a current threshold by the processor; when the output current to the stator is greater than or equal to the current threshold, fixing the present voltage of the power command by the processor; and when the output current to the stator is lower than the current threshold, increasing the present voltage of the power command by the processor.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a single-phase induction motor in some embodiments of the present disclosure.

FIG. 2 is a schematic diagram of the stator of the single-phase induction motor in some embodiments of the present disclosure.

FIG. 3 is a flowchart illustrating a motor drive method in some embodiments of the present disclosure.

FIG. 4A is a schematic diagram of the frequency variation of the single-phase induction motor in some embodiments of the present disclosure.

FIG. 4B is a schematic diagram of the voltage variation of the single-phase induction motor in some embodiments of the present disclosure.

FIG. 4C is a schematic diagram of the current variation of the single-phase induction motor in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly physically or electrically connected or coupled to the other element or intervening elements may be present. In contrast, when an element to another element is referred to as being “directly connected” or “directly coupled,” there are no intervening elements present. As used herein, the term “and/or” includes associated listed items or any and all combinations of more.

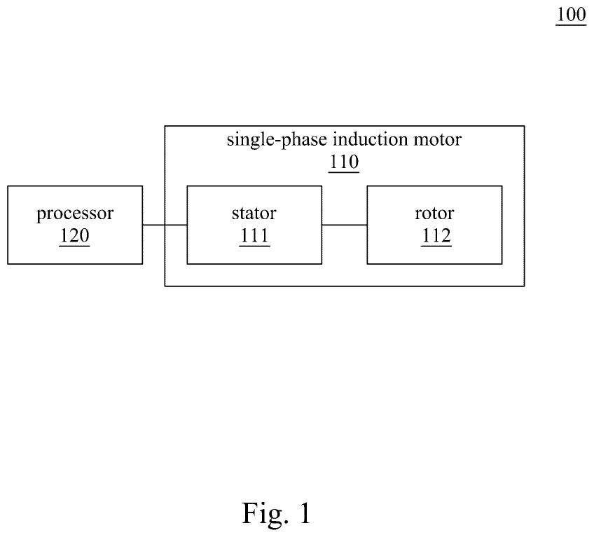

The present disclosure relates to a single-phase induction motor drive system and a motor drive method. As shown in FIG. 1, the single-phase induction motor drive system 100 includes a single-phase induction motor 110 and a processor 120. The single-phase induction motor 110 includes a stator 111 and a rotor 112. The processor 120 is coupled to the stator 111 of the single-phase induction motor 110 electrically, and is configured to supply power and output a power command to the stator 111 so that the stator 111 is configured to drive the rotor 112 of the single-phase induction motor 110. In subsequent embodiments, the single-phase alternating current (AC) power or control command provided by the processor 120 to the single-phase induction motor 110 is referred to as “power command”. The processor 120 of this disclosure has same or similar functions of an inverter or a motor drive.

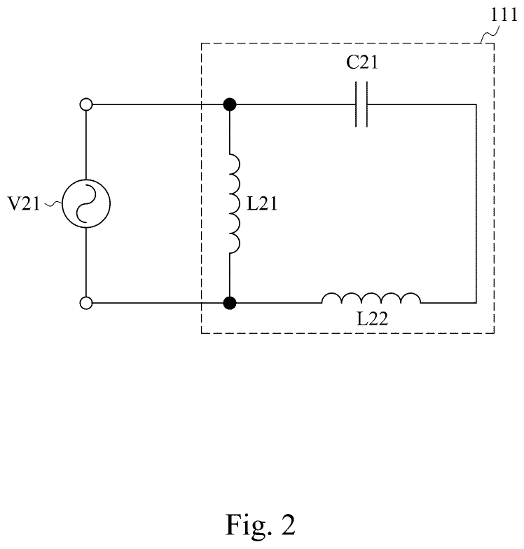

Since a single-phase AC power cannot directly generate a rotating magnetic field, an auxiliary circuit is required to achieve stable operation when the rotor 112 of the single-phase induction motor 110 starts up. FIG. 2 is a schematic diagram of the stator 111 of the single-phase induction motor 110 in some embodiments of the present disclosure. In this embodiment, the stator 111 includes a main winding L21, an auxiliary winding L22 and an auxiliary capacitor C21. The auxiliary winding L22 and the auxiliary capacitor C21 are the main components of an auxiliary circuit configured to assist in starting the single-phase induction motor 110, such that the magnetic fields generated by the main winding L21 and the auxiliary winding L22 drives the rotor 112 to rotate.

As mentioned above, according to the power command V21 provided by the processor 120, the auxiliary capacitor C21 changes the current phase, such that the current phase of the auxiliary winding L22 is out of phase with the current phase of the main winding L21, thereby generating an effect similar to a rotating magnetic field to drive the rotor 112 to rotate. When the rotation frequency of the rotor 112 reaches a preset frequency (hereinafter referred to as “target frequency”), it represents that the single-phase induction motor 110 is in a stable operating state. In some embodiments, the target frequency can be set according to the rated frequency of the single-phase induction motor 110, such as 50% of the rated frequency.

However, as shown in FIG. 2, during the process of the processor 120 starting the single-phase induction motor 110, the frequency of the power command V21 gradually rises from zero to the target frequency. When the frequency of the power command V21 is too low, the auxiliary capacitor C21 can be considered as an open circuit, and due to the extremely low impedance of the main winding L21, current does not flow through the auxiliary winding L22. Therefore, the auxiliary winding L22 cannot provide sufficient starting torque, making it difficult for the single-phase induction motor 110 to start and achieve stable operation.

The present disclosure is configured to enable the single-phase induction motor 110 to achieve stable operation by changing the control method of the processor 120 for the power command. Specifically, the processor 120 stores (or calculates to obtain) a frequency variation curve, wherein the frequency variation curve defines a corresponding relationship between time and the frequency of the power command. That is, the frequency variation curve indicates multiple reference frequencies of the power command (hereinafter referred to as “set frequencies”) at multiple different times during the rotation frequency starting from zero speed. The frequency variation curve further includes the target frequency (e.g., 30 Hz) for a time when the rotor 112 is in stable operation. The following table is a schematic illustration of one type of frequency variation curve:

| Startup time (seconds) | Set frequencies (Hz) |
|---|---|
| 0 | 0 |
| 1 | 5 |
| 2 | 10 |
| 3 | 15 |
| 4 | 20 |
| 5 | 25 |
| 6 | 30 |

The frequency variation curve is used as a reference for the processor 120 when controlling the power command. However, during the starting process, the processor 120 does not always control the frequency of the power command according to the frequency variation curve. When the power command is first provided to the stator 111, the processor 120 sets the initial frequency of the power command to a specific frequency value less than the target frequency, such as 12 Hz. Since the frequency of the power command will vary/change with time, for ease of subsequent description, the instantaneous frequency of the power command corresponding to the present time is referred to herein as “present frequency”.

As mentioned above, after being provided the power command (i.e., starts to activate the single-phase induction motor 110), the processor 120 will count the elapsed time and compare the relative magnitudes of “the initial frequency” and “one of the plurality of set frequencies corresponding to the present time in the frequency variation curve (the present frequency)”. If the present frequency corresponding to the present time is less than or equal to the initial frequency, the processor 120 maintains the present frequency of the power command at the initial frequency. On the other hand, if the present frequency corresponding to the present time is greater than the initial frequency, the processor 120 changes to control the present frequency of the power command according to the frequency variation curve. It should be noted that, ignoring other factors such as the influence of friction, the present frequency during rotation will be consistent with the set frequencies in the table.

For example, referring to the aforementioned schematic table of the frequency variation curve, if the initial frequency is 12 Hz, then within 2 seconds after the processor 120 starts the single-phase induction motor 110 (i.e., after being provided the power command), since the initial frequency is less than or equal to the set frequencies, the processor 120 maintains the present frequency of the power command at the initial frequency to continue the rotation. After 3 seconds from startup, since the set frequency (15 Hz) corresponding to the present time (3 seconds) in the frequency variation curve is greater than the initial frequency, the processor 120 changes to control the power command according to the frequency variation curve, that is, controlling the present frequency at 15 Hz at the 3rd second, at 20 Hz at the 4th second, and so on.

In some embodiments, when the present frequency corresponding to the present time is less than or equal to the initial frequency, the processor 120 is configured to increase the present voltage of the power command as much as possible to increase an output current provided by the processor 120 to the stator 111 (hereinafter referred to as “the output current to the stator 111”), thereby obtaining a higher torque as possible and improving the starting successful rate. The processor 120 further continuously detects the output current to the stator 111. When the output current to the stator 111 is greater than or equal to a preset current threshold, the processor 120 will limit and fix the output voltage to protect the single-phase induction motor 110, until the present frequency corresponding to the present time in the frequency variation curve is greater than the initial frequency. The current threshold can be set according to the rated current of the single-phase induction motor 110, such as 250% of the rated current.

Accordingly, by setting the initial frequency of the power command and changing to control the frequency of the power command with the frequency variation curve at a specific time, the problem of starting failure, which is caused by the frequency of the power command being too low during rotation frequency rises from zero speed and the auxiliary winding L22 cannot provide sufficient magnetic field for starting, is avoided. Furthermore, the processor 120 further detects the output current to the stator 111 to increase the voltage as quickly as possible within the current threshold range to increase the torque, thereby enabling the single-phase induction motor 110 to start more quickly and achieve stable operation earlier.

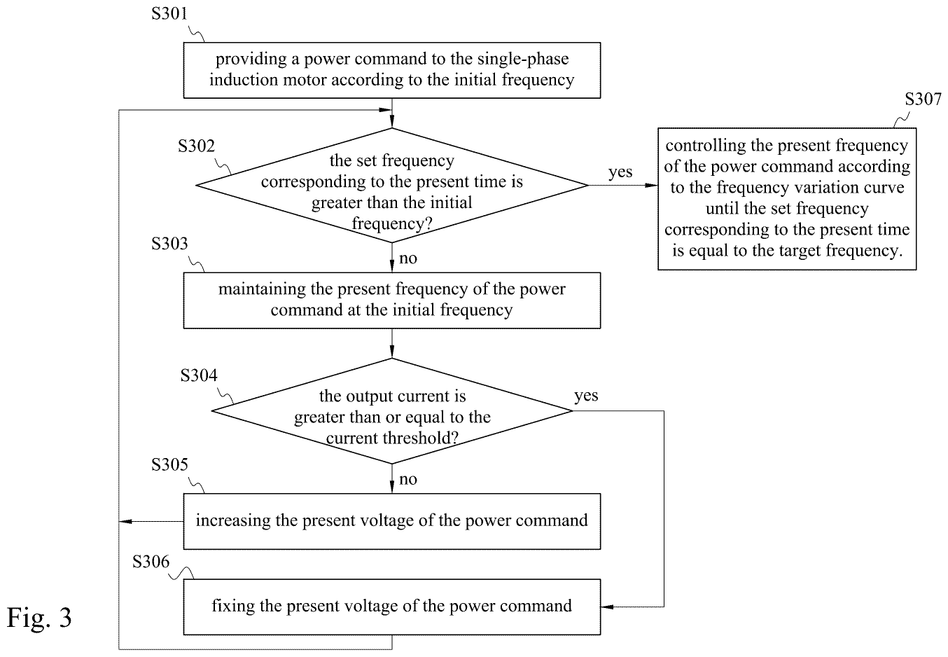

For ease of explanation, a motor driving method is described herein by taking the flowchart shown in FIG. 3 as an example. First, when the processor 120 is preparing to start the single-phase induction motor 110, the processor 120 obtains the aforementioned frequency variation curve. The frequency variation curve can be pre-stored in the processor 120, or generated by the processor 120 according to set parameters, or the processor 120 can be communicatively connected to a server to obtain the frequency variation curve; other control steps will be described later.

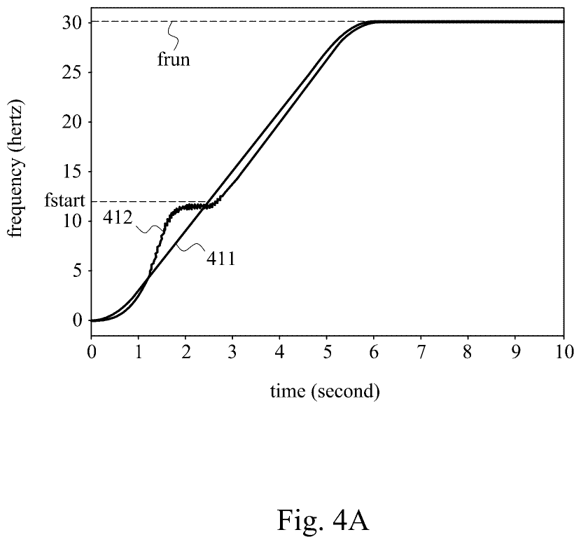

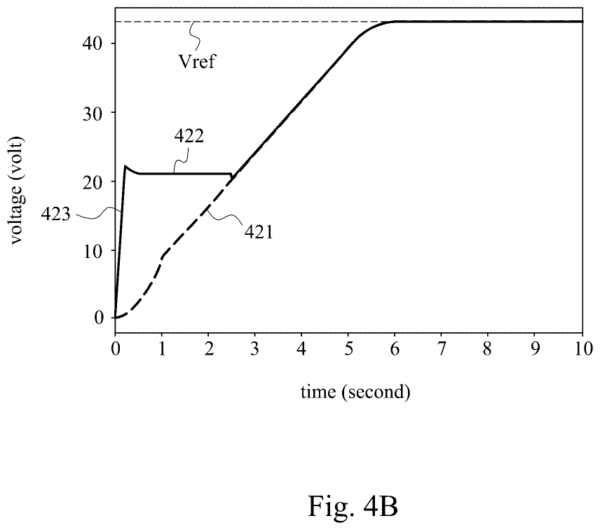

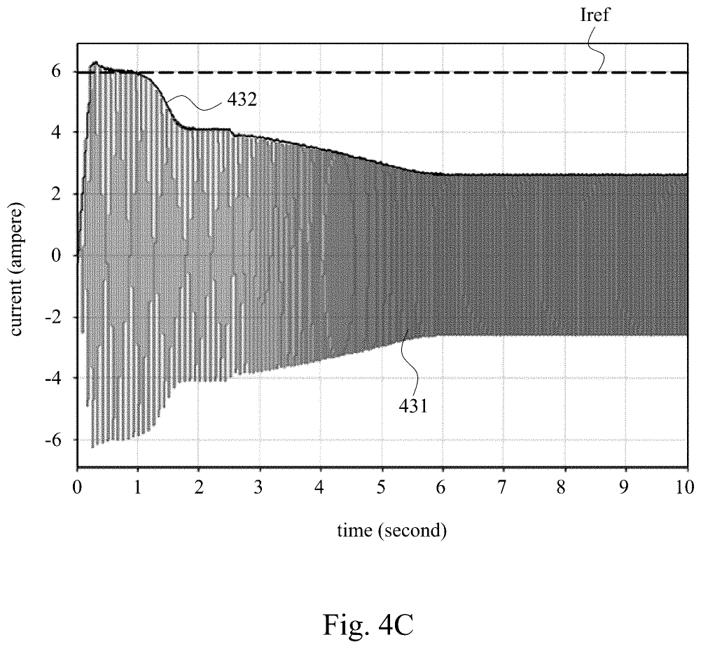

Please also refer to FIG. 4A, which is a schematic diagram of the frequency variation of the single-phase induction motor according to some embodiments of the present disclosure. The one labeled 411 is the frequency variation curve, the one labeled fstart is the initial frequency (e.g., 12 Hz), and the one labeled frun is the target frequency (e.g., 30 Hz). The one labeled 412 is a rotor actual frequency curve corresponding to the rotor frequency at different times in the method shown in FIG. 3. In one embodiment, the processor 120 generates and obtains the frequency variation curve 411 according to the target frequency frun and a preset period of the target time. The target time is a preset duration for completing the startup, such as 5 seconds or a time between 6 and 10 seconds. The processor 120 can calculate a preset variation slope according to the target time, that is, calculates an acceleration variation trend of the operating frequency of the rotor 112 from zero to the target frequency frun, and then plan the frequency variation curve 411. In other words, the frequency variation curve 411 is calculated and obtained by the processor 120, wherein the processor 120 controls the trend of the operating frequency of the rotor 112 rising from zero to the target frequency frun according to the variation slope.

In addition, in this embodiment, the processor 120 further generates a voltage variation curve corresponding to the frequency variation curve 411. The voltage variation curve is configured to indicate multiple set voltages at different times. Referring to FIG. 4B, which is a schematic diagram of the voltage variation of the single-phase induction motor according to some embodiments of the present disclosure, wherein the one labeled 421 is the voltage variation curve, which indicates the variation trend of the voltage rising from zero to a target voltage Vref during the target time. The one labeled 422 is an actual voltage curve of the power command corresponding to different times in the method shown in FIG. 3.

Please refer to FIG. 3 and FIGS. 4A-4C. In step S301, the processor 120 provides the power command to the stator 111 of the single-phase induction motor 110 according to the initial frequency fstart, such that the stator 111 is configured to drive the rotor 112 through the power command. The initial frequency fstart is less than the target frequency frun when the rotor 112 is in stable rotation. In some embodiments, the initial frequency fstart is between 5-99% of the target frequency frun. In one embodiment, the initial frequency fstart is between 15-75% of the target frequency frun. In one embodiment, the initial frequency fstart is between 40-60% of the target frequency frun.

In step S302, the processor 120 determines whether one of the plurality of set frequencies corresponding to the present time in the frequency variation curve 411 is greater than the initial frequency fstart. In other words, according to the currently count time, the processor 120 finds one set frequency corresponding to the present time on the frequency variation curve 411, and compares the set frequency with the initial frequency fstart. It should be noted that, ignoring other factors such as the influence of friction, the present frequency of the rotor 112 will be consistent with the set frequency.

If the set frequency corresponding to the present time is less than or equal to the initial frequency fstart, then in step S303, the processor 120 maintains the present frequency of the power command at the initial frequency fstart to drive the single-phase induction motor 110. As shown in FIG. 4A, before the startup time at 2.5 seconds, the set frequencies of the frequency variation curve 411 are all less than or equal to the initial frequency fstart.

Therefore, the frequency of the power command will be maintained at the initial frequency fstart.

Next, in step S304, the processor 120 will further determine whether the output current to the stator 111 is greater than or equal to the current threshold. Referring to FIG. 4C, which is a schematic diagram of the current variation of the single-phase induction motor 110 according to some embodiments of the present disclosure. The one labeled Iref is the current threshold, the one labeled 431 is the output current to the stator 111 corresponding to the present time, and the one labeled 432 is the envelope of the output current 431 to the stator 111, which represents the variation trend of the peak value of the output current 431 to the stator 111, wherein the peak value is calculated according to the sine wave of the output current 431 to the stator 111. In some embodiments, the processor 120 compares the peak value of the output current 431 to the stator 111 with the current threshold Iref to determine whether the output current 431 to the stator 111 is greater than or equal to the current threshold Iref. In other embodiments, the processor 120 can calculate the envelope 432 of the output current 431 to the stator 111 (or record multiple peak values of the output current 431 to the stator 111 at different times), and then compares the envelope 432 with the current threshold Iref to determine whether the output current 431 to the stator 111 is greater than or equal to the current threshold Iref.

If the output current 431 to the stator 111 is lower than the current threshold Iref, then in step S305, the processor 120 increases the present voltage of the power command according to the early-stage boost curve 423 of the actual voltage curve 422. Specifically, as shown in FIG. 4B, the processor 120 increases the present voltage of the power command according to a first variation rate (e.g., the slope of the early-stage boost curve 423 of the actual voltage curve 422 in FIG. 4B), and the first variation rate is greater than a second variation rate of the voltage variation curve 421 (i.e., the slope of the voltage variation curve 421).

In step S306, if the output current 431 to the stator 111 is greater than or equal to the current threshold Iref, at this time, the processor 120 will stop increasing the present voltage of the power command, and decrease the present voltage of the power command with a preset slope to suppress the output current 431 to the stator 111 to be lower than the current threshold Iref. Then, the present voltage of the power command is fixed or maintained until the set frequency corresponding to the present time of the frequency variation curve 411 is greater than the initial frequency fstart. In one embodiment, as shown in FIGS. 4B and 4C, the processor 120 will first decrease the present voltage of the power command with a preset slope to lower the output current 431 to the stator 111.

Once the output current 431 to the stator 111 is decreased to be less than the current threshold Iref, under the condition that the set frequency corresponding to the present time of the frequency variation curve 411 is less than the initial frequency fstart, the processor 120 will maintain the present voltage of the power command to ensure that the output current 431 to the stator 111 remains lower than the current threshold Iref.

In step S302, if the set frequency corresponding to the present time of the frequency variation curve 411 is greater than the initial frequency fstart, then in step S307, the processor 120 will no longer maintain the present voltage of the power command, and will no longer maintain the present frequency to be consistent at the initial frequency fstart. Instead, the processor 120 changes to control the present frequency of the power command according to the frequency variation curve 411. As shown in FIG. 4A, after the startup time at 2.5 seconds, since the present frequency of the frequency variation curve 411 is greater than the initial frequency fstart, the processor 120 will continue to increase the present frequency of the power command according to the frequency variation curve 411 until the present frequency of the power command is equal to the target frequency frun.

Similarly, during the process of increasing the present frequency of the power command, the processor 120 further controls/increases the present voltage of the power command according to the voltage variation curve 421, until the present voltage of the power command is equal to the target voltage Vref.

The motor driving method used in the present disclosure is configured to start the single-phase induction motor 110 by controlling the frequency and voltage of the power command. In some embodiments, controlling the voltage of the power command can affect the output current 431 to the stator 111, and when the output current 431 to the stator 111 approaches the current threshold Iref, the frequency of the rotor 112 will naturally be close to the frequency of the power command. Therefore, the processor 120 can complete the startup of the single-phase induction motor 110 without detecting the frequency of the rotor 112.

Overall, the single-phase induction motor drive system of the present disclosure can stably and quickly drive the rotor 112 of the single-phase induction motor 110 rising from zero speed and accelerating the rotor 112 to the target frequency frun, thereby avoiding startup failure and the need for additional restart. Furthermore, the motor driving method used in the present disclosure does not cause an excessive operational load on the processor 120, and can cause the rotor 112 to be driven to the target frequency frun within a preset time (e.g., the aforementioned target time), taking into account both stability and efficiency.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A single-phase induction motor drive system, comprising:
a single-phase induction motor comprising a stator and a rotor; and
a processor coupled to the stator, and configured to provide a power command to the stator, wherein the processor is configured to obtain a frequency variation curve, the frequency variation curve is configured to indicate a plurality of set frequencies corresponding to different times, and comprises a target frequency corresponding to a time when the single-phase induction motor is in stable operation;
wherein the processor is configured to determine the following conditions to provide the power command:
setting the present frequency of the power command with an initial frequency, such that the stator is configured to drive the rotor through the power command, wherein the initial frequency is less than the target frequency;
when one of the plurality of set frequencies corresponding to the present time is greater than the initial frequency, changing to control the present frequency of the power command according to the frequency variation curve;
when one of the plurality of set frequencies corresponding to the present time is less than or equal to the initial frequency, maintaining the present frequency of the power command at the initial frequency, and determining whether an output current to the stator is greater than or equal to a current threshold;
when the output current to the stator is greater than or equal to the current threshold, fixing the present voltage of the power command; and
when the output current to the stator is lower than the current threshold, increasing the present voltage of the power command.

2. The single-phase induction motor drive system of claim 1, wherein the processor is configured to obtain the frequency variation curve according to the target frequency and a target time.

3. The single-phase induction motor drive system of claim 2, wherein the frequency variation curve is obtained by the processor controlling an operating frequency of the rotor to increase from zero to the target frequency according to a variation slope.

4. The single-phase induction motor drive system of claim 1, wherein the processor is further configured to generate a voltage variation curve corresponding to the frequency variation curve, when the processor controls the present frequency of the power command according to the frequency variation curve, the processor is further configured to control the present voltage of the power command according to the voltage variation curve.

5. The single-phase induction motor drive system of claim 4, wherein when the output current to the stator is lower than the current threshold, the processor is configured to increase the present voltage of the power command according to a first variation rate, wherein a slope of the voltage variation curve corresponds to a second variation rate, and the first variation rate is greater than the second variation rate.

6. The single-phase induction motor drive system of claim 4, wherein when the output current to the stator is greater than or equal to the current threshold, the processor is configured to fix the present voltage of the power command until one of the plurality of set frequencies corresponding to the present time is greater than the initial frequency, and then the processor controls the present voltage of the power command according to the voltage variation curve.

7. The single-phase induction motor drive system of claim 1, wherein when the output current to the stator is greater than or equal to the current threshold, the processor is configured to decrease the present voltage of the power command according to a preset slope, and the processor maintains the present voltage of the power command after the output current to the stator is lower than the current threshold.

8. The single-phase induction motor drive system of claim 1, wherein the processor compares a peak value of the output current to the stator with the current threshold to determine whether the output current to the stator is greater than or equal to the current threshold.

9. The single-phase induction motor drive system of claim 8, wherein the processor is configured to calculate an envelope of the output current to the stator to determine whether the output current to the stator is greater than or equal to the current threshold, wherein the envelope represents a variation trend of the peak value.

10. The single-phase induction motor drive system of claim 1, wherein the initial frequency is between 15% and 75% of the target frequency.

11. A motor drive method, comprising:
obtaining, by a processor, a frequency variation curve corresponding to a single-phase induction motor, wherein the frequency variation curve is configured to indicate a plurality of set frequencies corresponding to different times, and comprises a target frequency corresponding to a time when the single-phase induction motor is in stable operation;
providing, by the processor, a power command to the single-phase induction motor, such that a stator of the single-phase induction motor drives a rotor of the single-phase induction motor to rotate, wherein an initial frequency of the power command is less than the target frequency;
when one of the plurality of set frequencies corresponding to the present time is greater than the initial frequency, controlling the present frequency of the power command according to the frequency variation curve by the processor;
when one of the plurality of set frequencies corresponding to the present time is less than or equal to the initial frequency, maintaining the present frequency of the power command at the initial frequency, and determining whether an output current to the stator is greater than or equal to a current threshold by the processor;
when the output current to the stator is greater than or equal to the current threshold, fixing the present voltage of the power command by the processor; and
when the output current to the stator is lower than the current threshold, increasing the present voltage of the power command by the processor.

12. The motor drive method of claim 11, further comprising:
obtaining, by the processor, the frequency variation curve according to the target frequency and a target time.

13. The motor drive method of claim 12, wherein the frequency variation curve is obtained by the processor controlling an operating frequency of the rotor to increase from zero to the target frequency according to a variation slope.

14. The motor drive method of claim 11, wherein the step of controlling the present frequency of the power command according to the frequency variation curve comprises:
controlling the present voltage of the power command according to a voltage variation curve, wherein the voltage variation curve corresponds to the frequency variation curve.

15. The motor drive method of claim 14, wherein the step of increasing the present voltage of the power command comprises:
increasing the present voltage of the power command according to a first variation rate, wherein a slope of the voltage variation curve corresponds to a second variation rate, and the first variation rate is greater than the second variation rate.

16. The motor drive method of claim 11, wherein the step of fixing the present voltage of the power command comprises:
fixing the present voltage of the power command until one of the plurality of set frequencies corresponding to the present time is greater than the initial frequency.

17. The motor drive method of claim 11, wherein the step of fixing the present voltage of the power command comprises:
decreasing the present voltage of the power command according to a preset slope; and
after the output current to the stator is lower than the current threshold, maintaining the present voltage of the power command.

18. The motor drive method of claim 11, wherein the step of determining whether the output current to the stator is greater than or equal to the current threshold comprises:
comparing a peak value of the output current to the stator with the current threshold to determine whether the output current to the stator is greater than or equal to the current threshold.

19. The motor drive method of claim 18, wherein the step of determining whether the output current to the stator is greater than or equal to the current threshold comprises:
calculating an envelope of the output current to the stator to determine whether the output current to the stator is greater than or equal to the current threshold, wherein the envelope represents a variation trend of the peak value.

20. The motor drive method of claim 11, wherein the initial frequency is between 15% and 75% of the target frequency.
